(19) United States
(12) Patent Application Publication
(10) Pub. No.: US 2026/0260565 A1
(43) Pub. Date: Sep. 3, 2026

(54) VEHICLE CONTROL DEVICE, VEHICLE CONTROL METHOD AND NON-TRANSITORY COMPUTER READABLE STORAGE MEDIUM

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 19/653,435

(22) Filed: Apr. 21, 2026

Related U.S. Application Data
(63) Continuation of application No. PCT/JP2025/005359, filed on Feb. 18, 2025.

(30) Foreign Application Priority Data
Mar. 6, 2024 (JP) 2024-034386

(51) Int. Cl. G08G 1/0965; B60W 40/08; B60W 50/14; B60W 60/00; G08G 1/0967

(52) U.S. Cl. CPC G08G 1/0965; B60W 40/08; B60W 50/14; B60W 60/0015; G08G 1/096725; B60W 2040/0818; B60W 2050/143; B60W 2050/146; B60W 2540/229; B60W 2552/05; B60W 2554/402

(57) ABSTRACT

A vehicle control device is used for a subject vehicle that can travel by autonomous driving and allows an occupant seated in a driver's seat to sleep. The vehicle control device detects the approach of an emergency vehicle to the subject vehicle. The vehicle control device grasps whether the occupant is asleep. When an emergency vehicle approaches the subject vehicle while the occupant is asleep during an autonomous driving period using the autonomous driving, the vehicle control device executes a restriction approach notification that notifies the occupant of an approach of the emergency vehicle using a display while restricting the awakening notification that prompts the occupant to wake up.

### CROSS REFERENCE TO RELATED APPLICATION

The present application is a continuation application of International Patent Application No. PCT/JP2025/005359 filed on Feb. 18, 2025, which designated the U.S. and claims the benefit of priority from Japanese Patent Application No. 2024-034386 filed on Mar. 6, 2024. The entire disclosures of all of the above applications are incorporated herein by reference.

### TECHNICAL FIELD

The disclosure of this specification relates to a vehicle control technology used in a vehicle capable of autonomous driving.

### BACKGROUND

The autonomous driving support device according to a conceivable technique includes an emergency vehicle detection unit that detects the approach of an emergency vehicle. When the emergency vehicle detection unit detects the approach of an emergency vehicle, the autonomous driving support device notifies the driver of the approach of the emergency vehicle and prompts the driver to focus on the driving operation using an awakening device.

### SUMMARY

According to an example, a vehicle control device is used for a subject vehicle that can travel by autonomous driving and allows an occupant seated in a driver's seat to sleep. The vehicle control device includes: at least one of (i) a circuit and (ii) a processor with a memory storing computer program code executable by the processor. The at least one of the circuit and the processor may be configured to cause the vehicle control device to: grasp an approach of an emergency vehicle to the subject vehicle; grasp whether the occupant is asleep; execute an emergency vehicle approach notification that notifies the occupant of the approach of the emergency vehicle; and execute a restriction approach notification that notifies the occupant of the approach of the emergency vehicle using a display while restricting an awakening notification that prompts the occupant to wake up when the emergency vehicle approaches the subject vehicle while the occupant is asleep during an autonomous driving period using the autonomous driving.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing an overall view of an in-vehicle network including an HMI control device and an autonomous driving ECU according to a first embodiment of the present disclosure;

FIG. 2 is a block diagram showing details of the autonomous driving ECU together with related configurations;

FIG. 3 is a block diagram showing details of an HMI control device together with related configurations;

FIG. 4 is a diagram showing a list of notification devices used to notify of the approach of an emergency vehicle;

FIG. 5 is a flowchart showing details of an emergency vehicle notification process executed by the HMI control device;

FIG. 6 is a flowchart showing details of an outside vehicle notification process executed by the HMI control device;

FIG. 7 is a flowchart showing details of an awakening response process executed by the HMI control device;

FIG. 8 is a flowchart showing details of an emergency vehicle notification process executed by an HMI control device according to a second embodiment of the present disclosure; and

FIG. 9 is a flowchart showing details of an emergency vehicle notification process executed by an HMI control device according to a third embodiment of the present disclosure.

### DETAILED DESCRIPTION

In the autonomous driving according to a conceivable technique, the driver is not permitted to sleep. Meanwhile, development of autonomous driving that allows drivers to sleep has been progressing in recent years. When responding to an emergency vehicle during the autonomous driving that allows a driver to sleep, if the notification disclosed in Patent Literature 1 is implemented, it will be difficult for the driver to continue sleeping. As a result, the convenience of the autonomous driving may be reduced.

The present embodiments provide a vehicle control device and a vehicle control method that are capable of responding to an emergency vehicle in a manner that is convenient for occupants.

In order to achieve the above object, one feature according to the present disclosure is a vehicle control device used in a subject vehicle that can travel by autonomous driving and allows a occupant seated in a driver's seat to sleep. The vehicle control device includes: an approach detection unit that detects the approach of an emergency vehicle to the subject vehicle; a state detection unit that detects whether the occupant is asleep; and a notification execution unit that issues an emergency approach notification to the occupant that an emergency vehicle is approaching. When an emergency vehicle approaches the subject vehicle while the occupant is asleep during an autonomous driving period using the autonomous driving, the notification execution unit executes a restriction approach notification that indicates approach of the emergency vehicle to the occupant using a display while restricting the awakening notification that prompts the occupant to wake up.

Another feature according to the present disclosure is a vehicle control method used in a subject vehicle that can travel by autonomous driving and allows a occupant seated in a driver's seat to sleep. The vehicle control method includes a process executed by at least one processing unit. The process includes: detecting the approach of an emergency vehicle to the subject vehicle; detecting whether the occupant is asleep; and executing a restriction approach notification that indicates approach of the emergency vehicle to the occupant using a display while restricting an awakening notification that prompts the occupant to wake up when the emergency vehicle approaches the subject vehicle while the occupant is asleep during an autonomous driving period using the autonomous driving.

In these features, even if the approach of an emergency vehicle is detected, the awakening notification that prompts the occupant to wake up is restricted, so the occupant can continue sleeping. In addition, since the approach of an emergency vehicle is indicated to the occupant by a display, the occupant can understand from the display that an emergency vehicle is approaching, even if the occupant suddenly wakes up. As a result, emergency vehicle response can be provided in a way that is convenient for an occupant.

The reference numerals in the parentheses in features are just examples of the correspondence with the specific components in the embodiments, and do not restrict the scope of the present disclosure. In addition, combinations of claims that are not explicitly stated in claims by dependency are also included in a scope of the present disclosure unless there is a particular difficulty existing in the combination.

The following will describe embodiments of the present disclosure with reference to accompanying drawings. In the following description, the same reference symbols are assigned to corresponding components in each embodiment in order to avoid repetitive descriptions. In each of the embodiments, when only a part of the configuration is described, the remaining parts of the configuration may adopt corresponding parts of other embodiments. Further, not only the combinations of the configurations explicitly shown in the description of the respective embodiments, but also the configurations of multiple embodiments can be partially combined even when they are not explicitly shown as long as there is no difficulty in the combination in particular.

### First Embodiment

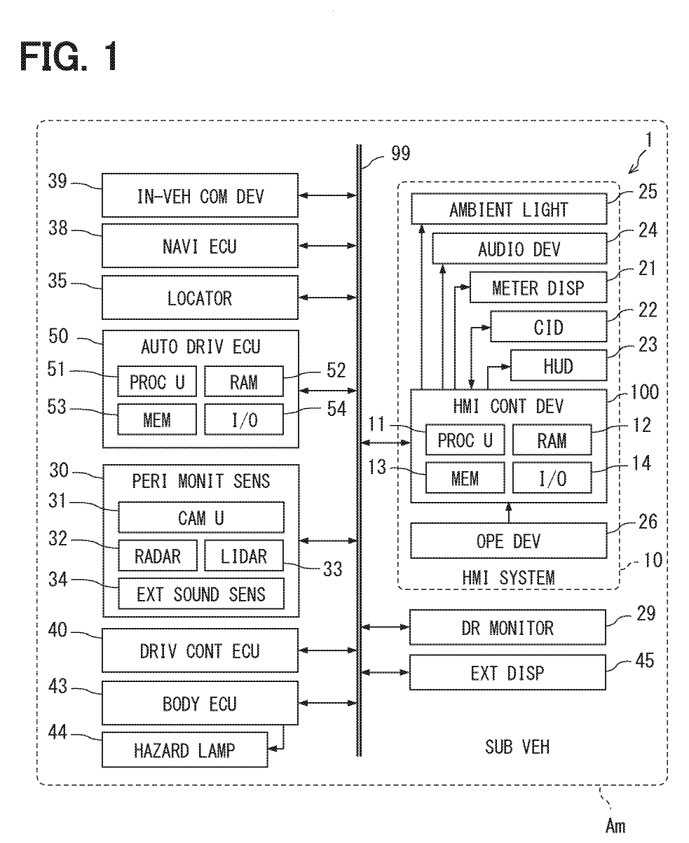

The functions of the vehicle control device according to the first embodiment of the present disclosure are realized by an HMI (Human Machine Interface) control device 100 shown in FIG. 1. The HMI control device 100 is an interface control device used in a vehicle (hereinafter referred to as subject vehicle Am). The HMI control device 100 constitutes a human machine interface (HMI) system 10 of the subject vehicle Am together with multiple input and output devices and the like. The HMI system 10 has an input interface function of receiving an operation made by an occupant, such as a driver of the host vehicle Am. The HMI system 10 has an output interface function of presenting information to the occupant, such as the driver.

The HMI control device 100 is communicably connected to a communication bus 99 of an in-vehicle network 1 mounted on the subject vehicle Am. The HMI control device 100 is one of multiple nodes included in the in-vehicle network 1. An autonomous driving ECU (Electronic Control Unit) 50 is connected to the communication bus 99 of the in-vehicle network 1.

The autonomous driving ECU 50 is mounted on the subject vehicle Am together with the HMI control device 100. The subject vehicle Am mounting the autonomous driving ECU 50 is an automated driving vehicle or an autonomous traveling vehicle equipped with an autonomous driving function. The autonomous driving level in this disclosure is defined based on standards established by the Society of Automotive Engineers in the US. In the present disclosure, "autonomous driving control" refers to the automated traveling control of autonomous driving level 3 or higher by the autonomous driving ECU 50.

The autonomous driving at Level 3 is an eyes-off autonomous driving in which the monitoring around the subject vehicle is unnecessary and there is no periphery monitoring obligation. The autonomous driving ECU 50 is capable of executing the fully autonomous driving with the level 4, in which the system executes all driving tasks under certain conditions. The autonomous driving at Level 4 is brain-off autonomous driving in which a request for a driver to take over a driving operation does not substantially occur. The autonomous driving ECU 50 may further be capable of executing the fully autonomous driving with the level 5, in which the system executes all driving tasks under all conditions. The autonomous driving at Level 5 is driverless autonomous driving that does not require a driver to get on.

During the autonomous driving period in which the subject vehicle Am is travelling by the autonomous driving ECU 50 under autonomous driving control of autonomous driving level 3 or higher, the driver may be permitted to execute specific actions (hereinafter referred to as second tasks) other than driving operation as defined in advance. The second task is legally permitted to the driver until a takeover request (TOR) is made by the autonomous driving ECU 50 in cooperation with the HMI control device 100. Supposed examples of the second tasks include watching entertainment contents such as video, operating a device such as smartphone, and eating. Furthermore, during the autonomous driving period in which the subject vehicle Am is travelling by the autonomous driving control of the autonomous driving level 4 or higher, the occupant (or a driver) seated in the driver's seat is allowed to sleep.

The communication bus 99 is further connected to a driver monitor 29, a periphery monitoring sensor 30, a locator 35, a navigation ECU 38, an in-vehicle communication device 39, a driving control ECU 40, a body ECU 43, an exterior display 45, and the like. Multiple nodes connected to the communication bus 99 can communicate with each other. Among these ECUs, and the like, specific nodes may have direct electrical connection therebetween and may be communicable with each other not via the communication bus 99.

The driver monitor 29 continuously monitors the state of the occupant seated in the driver's seat. The driver monitor 29 includes a near-infrared light source, a near-infrared camera, and a control unit that controls these components. The driver monitor 29 is installed, for example, to an upper surface of a steering column, an upper surface of an instrument panel, or the like to have a posture such that the near-infrared camera is directed to a headrest of the driver's seat. The driver monitor 29 captures, using the near-infrared camera, an image of the head of the driver, which is irradiated with near-infrared light by the near-infrared light source. The image captured by the near-infrared camera is analyzed by the control unit. The control unit extracts information such as the driver's facial orientation, eye point position, line of sight direction, and eye opening degree from the captured image. The control unit generates wakefulness information indicating whether the driver is asleep or not based on the extracted information from the captured image. The driver monitor 29 provides the HMI control device 100, and the like with information on the face direction, eye point position, line of sight direction, eye opening degree, and the like extracted by the control unit, as well as wakefulness information based on this information, as driver status information.

The periphery monitoring sensor 30 is an autonomous sensor that is mounted to the subject vehicle Am and monitors an environment around the subject vehicle Am. The periphery monitoring sensor 30 can detect a moving object or a stationary object from a detection range around the subject vehicle. The periphery monitoring sensor 30 provides detection information on an object around the subject vehicle to the autonomous driving ECU 50, and the like. The periphery monitoring sensor 30 includes a camera unit 31, a millimeter wave radar 32, a lidar 33, and an exterior acoustic sensor 34. The periphery monitoring sensor 30 may further include a sonar sensor or the like.

The camera unit 31 includes a front camera module, a rear camera module, a left-side camera module, and a right-side camera module, and the like. The camera unit 31 can capture an image of an area all around the subject vehicle Am by having multiple camera modules. The camera unit 31 provides the autonomous driving ECU 50 with the image data captured by each camera module or analysis information of the image data as detection information.

The millimeter wave radar 32 emits millimeter waves or quasi-millimeter waves toward the surroundings of the subject vehicle. The millimeter wave radar 32 provides the autonomous driving ECU 50 with detection information generated by a process of receiving reflected waves from moving objects, stationary objects, and the like.

The lidar 33 emits laser light toward the surroundings of the subject vehicle. The lidar 33 provides the autonomous driving ECU 50 with detection information (i.e., point cloud data) generated by a process of receiving laser light reflected by moving objects and stationary objects disposed within the irradiation range.

The exterior acoustic sensor 34 includes, as its main configuration, a microphone element for converting sound into an electrical signal. The exterior acoustic sensor 34 is held by an exterior structure of the subject vehicle Am in a position in which a sound-collecting surface of a microphone element or the like is directed toward the exterior structure of the subject vehicle Am. Multiple exterior acoustic sensors 34 are arranged to a front side, a rear side, a right side, a left side, and a ceiling of the subject vehicle Am. The exterior acoustic sensors 34 provided at various locations can detect sounds coming from all around the subject vehicle Am, and collect environmental sounds around the subject vehicle Am. As an example, when an emergency vehicle is approaching the subject vehicle Am, the exterior acoustic sensor 34 collects environmental sounds including a specific siren sound sounded by the emergency vehicle and sound from a loudspeaker. The exterior acoustic sensor 34 provides the autonomous driving ECU 50 with sound data of the environmental sounds generated by each microphone element or analysis information of the sound data (such as information that a siren sound has been extracted) as detection information. In addition, the emergency vehicle in this disclosure includes a police vehicle, a fire engine, an ambulance, and the like, and unless otherwise specified, refer to the emergency vehicle traveling for emergency purposes and sounding a siren.

The locator 35 includes a GNSS (global navigation satellite systems) receiver, an inertial sensor, and the like. The locator 35 combines positioning signals received by the GNSS receiver from multiple positioning satellites, measurement result of an inertial sensor, vehicle speed information output to the communication bus 99, and the like, and successively specifies a position and a travelling direction of the host vehicle Am. The locator 35 sequentially outputs, as locator information, the position information and direction information of the subject vehicle Am based on a positioning result to the communication bus 99.

The locator 35 further includes a map database that stores map data. The map database includes, as its main configuration, a storage medium of a large capacity storing a number of 3D map data and 2D map data. The 3D map data are so-called HD (High Definition) maps, which include road information necessary for autonomous driving. Specifically, the 3D map data includes information on a 3D shape of a road and detailed information on each lane. The locator 35 can update the 3D map data and the 2D map data to the latest information via the in-vehicle communication device 39 executing communication with an outside of the vehicle. The locator 35 reads map data of the area around the current location from a map database and provides it to the autonomous driving ECU 50, the HMI control device 100, and the like together with locator information.

The navigation ECU 38 acquires information on a destination designated by an occupant such as the driver or the like, based on operation information acquired from the HMI control device 100. The navigation ECU 38 acquires the subject vehicle location and direction information from the locator 35 and sets a route from the current position to the destination. The navigation ECU 38 provides route information indicating the set route to the destination to the autonomous driving ECU 50, the HMI control device 100, and the like. The navigation ECU 38 cooperates with the HMI control device 100, combines screen display, voice messages, and the like as route guidance to the destination, and notifies the driver of the traveling direction of the subject vehicle Am at an intersection, a branch point, and the like.

A user terminal such as a smartphone and a tablet may be connected to the in-vehicle network 1 or the HMI control device 100. Such a user terminal may provide information on the subject vehicle location, the direction information, and the map data to the autonomous driving ECU 50, and the like, in place of the locator 35. Furthermore, the user terminal may provide the autonomous driving ECU 50, the HMI control device 100, and the like with the information on the route to the destination, in place of the navigation ECU 38. The user terminal may also execute playback of video content, and the like, in place of the below described HMI system 10 or together with the HMI system 10.

The in-vehicle communication device 39 is an in-vehicle external communication device mounted on the subject vehicle Am. The in-vehicle communication device 39 functions as a Vehicle to Everything (V2X) communication device. The in-vehicle communication device 39 transmits and receives information via wireless communication with roadside devices installed on the side of the road and with in-vehicle communication devices 39 of other vehicles. For example, the in-vehicle communication device 39 acquires detection information of stopped vehicles, parked vehicles, pedestrians, cyclists, and the like from the roadside devices. The in-vehicle communication device 39 may be capable of acquiring emergency vehicle approach information indicating the approach of an emergency vehicle from a roadside device or another vehicle. The in-vehicle communication device 39 provides the received detection information, emergency vehicle approach information, and the like to the navigation ECU 38, the autonomous driving ECU 50, the HMI control device 100, and the like as received traffic information.

The drive control ECU 40 is an electronic control unit including a microcontroller as its main component. The drive control ECU 40 has at least functions of a brake control ECU, a drive control ECU, and a steering control ECU. The traveling control ECU 40 continuously executes a braking force control of each wheel, an output control of a powertrain, and a steering angle control based on any of an operation command based on the driver's driving operation and a control command from the autonomous driving ECU 50.

The body ECU 43 is an electronic control unit including a microcontroller as its main component. The body ECU 43 has a function of controlling various in-vehicle devices (for example, lighting devices) mounted on the subject vehicle Am. The lighting devices include direction indicators and emergency flashers (hereinafter referred to as hazard lamps 44). The body ECU 43 starts flashing the hazard lamps 44 based on the detection of a user operation input to a hazard switch provided on an instrument panel or the like. During the autonomous driving period, the body ECU 43 causes the hazard lamps 44 to flash based on a control command from the autonomous driving ECU 50.

The exterior display 45 is provided on the outer surface of the subject vehicle Am. The exterior display 45 is an exterior notification device that displays information to the outside of the subject vehicle Am. The exterior display 45 is configured to be able to display text. The subject vehicle Am is equipped with at least one of a front display, a side display, a rear display, and the like as an exterior display 45. The exterior display 45 notifies pedestrians, cyclists, drivers of other vehicles, and the like around the subject vehicle of the operating status of the autonomous driving of the subject vehicle Am and various information grasped by the subject vehicle Am. The subject vehicle Am may further be provided with an exterior speaker as an exterior notification device that reproduces an alarm sound or a voice message to the outside of the subject vehicle. The exterior display 45 may also be a light-emitting device that indicates information by changing the light emission pattern.

### Configuration of the Autonomous Driving ECU

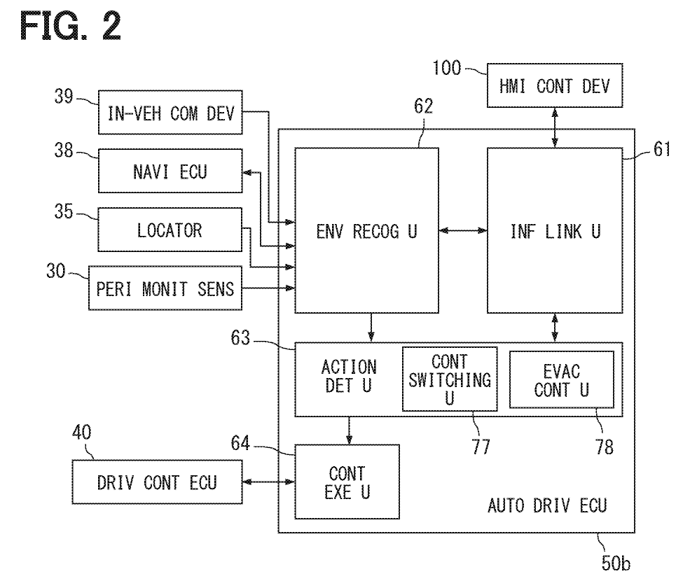

The autonomous driving ECU 50 shown in FIGS. 1 and 2 is a computer including a control circuit as its main component, the control circuit including a processing unit 51, a RAM 52, a memory 53, an input/output interface 54, and a bus connecting these elements. The processing unit 51 accesses the RAM 52 to execute various processes (i.e., instructions) for realizing the autonomous driving control method and vehicle control method according to the present disclosure. The memory 53 stores various programs (such as an autonomous driving control program and a vehicle control program) executed by the processing unit 51. By executing the program by the processing unit 51, in the autonomous driving ECU 50, an information linkage unit 61, an environment recognition unit 62, an action determination unit 63, a control execution unit 64, and the like are established as functional units for realizing autonomous driving functions and vehicle control functions.

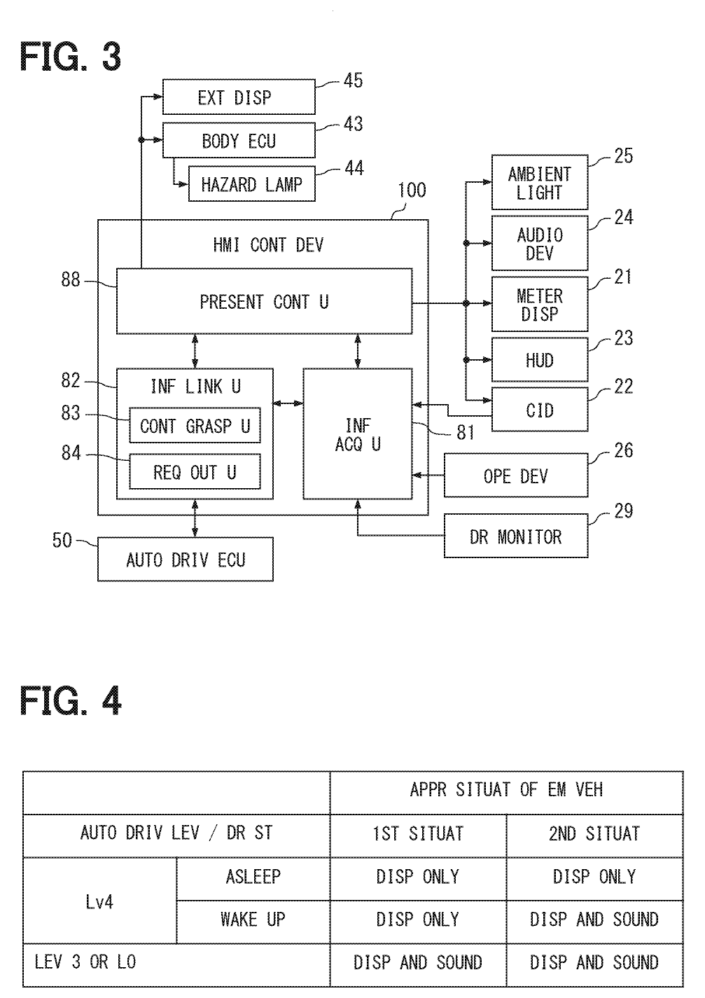

The information linkage unit 61 provides information to an information linkage unit 82 (see FIG. 3) of the HMI control device 100 and acquires information from the information linkage unit 82. Through cooperation between these information linkage units 61 and 82, the autonomous driving ECU 50 and the HMI control device 100 share the information that each of them has acquired.

The information linkage unit 61 generates control status information indicating an operation state of the autonomous driving function and provides the generated control status information to the information linkage unit 82. The information linkage unit 61 provides the information linkage unit 82 with the results of recognition of the surroundings of the vehicle by the environment recognition unit 62. Furthermore, the information linkage unit 61 outputs a request to the information linkage unit 82 to make a notification, thereby enabling the HMI control device 100 to make a notification in synchronization with the operation state of the autonomous driving function. The information linkage unit 61 acquires operation information and control requests related to autonomous driving from the information linkage unit 82.

The environment recognition unit 62 recognizes the traveling environment of the subject vehicle Am by combining: the locator information and the map data acquired from the locator 35; and the detection information acquired from the periphery monitoring sensor 30. The environment recognition unit 62 may use the detection information received by the in-vehicle communication device 39 to recognize the driving environment. The environment recognition unit 62 acquires road information related to the road on which the subject vehicle Am is traveling or is scheduled to travel, and grasps the size, relative position, relative speed, and the like of movable targets around the subject vehicle located on the road. The environment recognition unit 62 provides the action determination unit 63 with the recognition result of the driving environment including the grasped road information and target information, and the route information acquired from the navigation ECU 38.

The environment recognition unit 62 detects the approach of an emergency vehicle based on acoustic recognition technique using the detection information of the exterior acoustic sensor 34. The environment recognition unit 62 further detects the type, relative position, and direction of movement of the emergency vehicle whose approach has been recognized. Specifically, the environment recognition unit 62 determines whether or not an emergency vehicle is traveling on the same road and in the same direction as the subject vehicle Am. Furthermore, the environment recognition unit 62 estimates whether or not the subject vehicle Am is obstructing the travel of an emergency vehicle. As an example, if an emergency vehicle approaching the subject vehicle Am from behind is unable to overtake (or pass) the subject vehicle Am and remains behind the subject vehicle Am, the environment recognition unit 62 estimates that the subject vehicle Am is obstructing the travel of the emergency vehicle. Specifically, when an audio announcement to give way is detected, or when the approaching state of an emergency vehicle continues for a predetermined period of time (e.g., 10 to several tens of seconds) or longer, the environment recognition unit 62 estimates that the subject vehicle Am is obstructing the travel of the emergency vehicle. The environment recognition unit 62 provides the recognition result related to the emergency vehicle to the HMI control device 100 via the information linkage unit 61.

When the autonomous driving ECU 50 has the right to control the driving operation, the action determination unit 63 determines the action of the subject vehicle Am based on the results of the recognition of the driving environment by the environment recognition unit 62. The action determination unit 63 generates a planned driving line along which the subject vehicle Am will travel, and outputs the generated planned driving line to the control execution unit 64. The action determination unit 63 has a control switching unit 77 and an evacuation control unit 78 as sub-functional units.

The control switching unit 77 cooperates with the driving control ECU 40 to switch the control state of the subject vehicle Am between the autonomous driving and manual driving. In addition, the control switching unit 77 switches the autonomous driving level of the autonomous driving control implemented in the subject vehicle Am. For example, when the information linkage unit 61 detects an input of a switching operation to level 3 or level 4, the control switching unit 77 switches the driving control state of the subject vehicle Am from the manual driving or the driving support control at level 2 or below to the autonomous driving control at level 3 or higher. Furthermore, when the control switching unit 77 determines to end the autonomous driving control, the control switching unit 77 switches the driving control state from the autonomous driving control to the driving support control or manual driving. In addition, during an autonomous driving period of autonomous driving level 4 or higher, if the driver is not in a state suitable for manual driving, the control switching unit 77 restricts (or prohibits) switching (i.e., overriding) from the autonomous driving to the manual driving. In this case, the control switching unit 77 cooperates with the driving control ECU 40 to prohibit the driver from executing driving operations by not reflecting the driving operations input to the driving operators on the behavior of the subject vehicle Am.

When the environment recognition unit 62 detects an emergency vehicle approaching the subject vehicle Am, the evacuation control unit 78 executes a corresponding driving control to respond to the approach of the emergency vehicle. The evacuation control unit 78 controls the behavior of the subject vehicle Am so as to avoid the emergency vehicle while grasping the status of other vehicles traveling around the subject vehicle Am through adaptive travel control. The evacuation control unit 78 executes at least one of stop control, low-speed travel control, departure control, and reroute control as the adaptive travel control. The stop control is a control to stop the subject vehicle Am at a position away from the emergency vehicle by a predetermined distance or more. The low-speed travel control is a control to suppress the traveling speed of the subject vehicle Am. The departure control is a control for changing a traffic lane to cause the subject vehicle Am to exit the traffic lane in which the subject vehicle is traveling when the subject vehicle Am is traveling in the same lane as an emergency vehicle. The reroute control is a control to reestablish the scheduled travel route of the subject vehicle Am so as to avoid an estimated travel route of the emergency vehicle. The change of the scheduled driving route by the reroute control may be realized by the action determination unit 63 changing the scheduled driving line, or may be realized by the process of outputting a reroute request to the navigation ECU 38. Information indicating the start and end of the adaptive travel control and information indicating the type of adaptive travel control currently being executed is provided to the HMI control device 100 from the information linkage unit 61 as part of control status information.

When the autonomous driving ECU 50 has the right to control the driving operations, the control execution unit 64 executes control of acceleration and deceleration, steering operation and the like of the subject vehicle Am following the scheduled traveling line generated by the action determination unit 63 in cooperation with the driving control ECU 40. Specifically, the control execution unit 64 generates a control command based on the scheduled traveling line and successively outputs the generated control command to the driving control ECU 40.

### HMI Control Device

The HMI control device 100 shown in FIGS. 1 to 3 constitutes an HMI system 10 together with a plurality of display devices, an audio device 24, an ambient light 25, an operation device 26, and the like. The display device visually presents information to the driver by displaying images, and the like. The display device includes a meter display 21, a center information display (hereinafter called CID) 22, and a head-up display (hereinafter called HUD) 23. The CID 22 has a touch panel function and detects a touch operation to the display screen by the driver or the like.

The audio device 24 includes a plurality of speakers mounted in the compartment of the subject vehicle. The audio device 24 reproduces a notification sound or voice message, and the like in the compartment by means of a speaker. The ambient light 25 is arranged to an instrument panel, a center console, a steering wheel, a door trim, and the like. The ambient light 25 executes ambient display to change emission color, thereby executing information presentation utilizing the driver's peripheral vision.

The operation device 26 is an input unit that receives a user operation executed by driver or the like. The operation device 26 receives the input of user operations related to, for example, activating and deactivating the autonomous driving function, and user operations related to setting a destination for route guidance. The operation device 26 includes a steer switch arranged on a spoke of a steering wheel, a control lever arranged to a steering column, and a sound input device that recognizes a voice message of the occupant.

The HMI control device 100 functions as a presentation control device and integrally controls information presentation using the multiple display devices, the audio device 24, the ambient light 25, and the like. The HMI control device 100, in cooperation with the autonomous driving ECU 50, presents information related to the autonomous driving. For example, when the autonomous driving control is scheduled to be ended by the autonomous driving ECU 50, the HMI control device 100 notifies the driver about a request for driving operation takeover.

The HMI control device 100 is a computer including a control circuit as its main component, the control circuit including a processing unit 11, a RAM 12, a memory 13, an input/output interface 14, and a bus connecting these elements. The processing unit 11 accesses the RAM 12 to execute various processes (i.e., instructions) for realizing the presentation control method and vehicle control method according to the present disclosure. The memory 13 stores various programs (such as a presentation control program and a vehicle control program) executed by the processing unit 11. By executing the program by the processing unit 11, in the HMI control device 100, an information acquisition unit 81, an information linkage unit 82, a presentation control unit 88, and the like are established as functional units for realizing the presentation control function and the vehicle control function.

The information acquisition unit 81 acquires vehicle information (for example, vehicle speed information) indicating the state of subject vehicle Am from the communication bus 99. The information acquisition unit 81 determines whether the subject vehicle Am is stopped or not based on the vehicle speed information. Additionally, the information acquisition unit 81 acquires operation information indicating the details of the driver's operation from the CID 22, the operation device 26, and the like. Furthermore, the information acquisition unit 81 acquires driver status information from the driver monitor 29. The information acquisition unit 81 continuously determines whether the driver is awake or asleep based on the wakefulness information included in the driver status information.

During the autonomous driving period of autonomous driving level 4 or higher, the occupant sitting in the driver's seat corresponds to the driver for convenience. The driver's seat is a seat suitable for operating the driving operation units such as the accelerator pedal, brake pedal, and steering wheel, and is provided near the driving operation units.

The information linkage unit 82 cooperates with the information linkage unit 61 of the autonomous driving ECU 50, and enables information to be shared between the autonomous driving ECU 50 and the HMI control device 100. The information linkage unit 82 acquires from the autonomous driving ECU 50 execution requests for the presentation of information related to the autonomous driving function, the recognition results of the surroundings of the subject vehicle, and control status information indicating the operation state of the autonomous driving function. The information linkage unit 82 provides the acquired execution request, recognition result, control status information, and the like to the presentation control unit 88. The information linkage unit 82 provides the autonomous driving ECU 50 with information related to the autonomous driving among the operation information grasped by the information acquisition unit 81. The information linkage unit 82 has a control grasp unit 83 and a request output unit 84 as sub-functional units for information linkage with the autonomous driving ECU 50.

The control grasp unit 83 grasps the autonomous driving level of the driving control executed by the autonomous driving ECU 50 based on the control status information acquired by the information linkage unit 82. The control grasp unit 83 grasps the approach of an emergency vehicle to the subject vehicle Am based on the recognition results of the surroundings of the subject vehicle acquired by the information linkage unit 82. Based on the recognition result, the control grasp unit 83 further grasps whether or not an emergency vehicle is traveling in the same direction as the subject vehicle Am. In the following description, a situation in which the approach of an emergency vehicle is detected but it is unclear whether the emergency vehicle is traveling in the same direction as the subject vehicle is referred to as a "first situation." Furthermore, a situation in which the approach of an emergency vehicle is detected and it is further detected that the emergency vehicle is traveling in the same direction is referred to as a "second situation."

When the control grasp unit 83 grasps that an emergency vehicle is approaching, the control grasp unit 83 grasps, based on the recognition result, the possibility that the emergency vehicle will not be able to pass through the subject vehicle Am, in other words, whether the subject vehicle Am is obstructing the travel of the emergency vehicle. In addition, when the control grasp unit 83 grasps that an emergency vehicle is approaching, the control grasp unit 83 grasps, based on the control status information, whether or not the evacuation control unit 78 is executing the adaptive travel control. If the adaptive travel control is being executed, the control grasp unit 83 further grasps the type of adaptive travel control being executed.

The request output unit 84 outputs a control request related to autonomous driving to the autonomous driving ECU 50. Specifically, if the driver is asleep during an autonomous driving period at autonomous driving level 4 or higher, the request output unit 84 outputs a control request to the autonomous driving ECU 50 requesting prohibition of transition to the manual driving. The request output unit 84 continues to output a control request to prohibit a transition to the manual driving to the autonomous driving ECU 50 even after the driver has changed from a sleep state to an awake state. As described above, the request output unit 84 cooperates with the control switching unit 77 to prohibit (or restrict) the manual driving by a driver who is asleep and a driver who has just woken up. The request output unit 84 continues to restrict the manual driving until the driver, who has become awake, assumes a position (i.e., driving posture) that allows the driver to take over the driving operation, or until a predetermined time (e.g., approximately 10 seconds) has elapsed after the driver becomes awake. The request output unit 84 or the driver monitor 29 determines that the driver is ready to take over the driving operation when the driver executes an action such as gripping the steering wheel or returning the driver's seat to its original position.

If the driver wakes up while the evacuation control unit 78 is executing the adaptive travel control for an emergency vehicle, the request output unit 84 temporarily suspends the adaptive travel control currently being executed. The request output unit 84 outputs a control request to the autonomous driving ECU 50 to request that the adaptive travel control be suspended. The evacuation control unit 78 suspends the stop control, low-speed travel control, and departure control that are currently being executed based on the control request. Specifically, the evacuation control unit 78 executes control such as temporarily suspending lateral movement and temporarily suspending deceleration and continuing to travel at the current vehicle speed.

The presentation control unit 88 integrally provides information to the driver using each display device, the audio device 24, and the ambient light 25 (hereinafter, referred to as an information presentation device). The presentation control unit 88 provides content and presents information in accordance with the operation state of the autonomous driving based on the execution request, recognition results, and control status information provided by the information linkage unit 82. When the presentation control unit 88 determines that the autonomous driving control of autonomous driving level 3 or higher is being executed, the presentation control unit 88 enables the playback of video content, and the like. When the autonomous driving control is scheduled to end, the presentation control unit 88 requests the driver to take over the driving operation and the like. Furthermore, when the information linkage unit 82 detects that an emergency vehicle is approaching the subject vehicle Am, the presentation control unit 88 issues an emergency approach notification to inform occupants such as the driver of the approach of the emergency vehicle.

The presentation control unit 88 executes an exterior notification using the hazard lamps 44 and the exterior display 45. In a first situation in which it is grasped that an emergency vehicle is approaching the subject vehicle Am, the presentation control unit 88 uses the exterior display 45 to notify the outside of the subject vehicle that an emergency vehicle is approaching. When the subject vehicle Am is equipped with a plurality of exterior displays 45, the presentation control unit 88 uses at least the rear display to notify following vehicles of the approach of an emergency vehicle. In addition, in a second situation where it is grasped that an emergency vehicle is traveling in the same direction as the subject vehicle Am, the presentation control unit 88 not only issues an exterior notification via the exterior display 45, but also starts flashing the hazard lamps 44 of the subject vehicle Am. The flashing operation of the hazard lamps 44 may be started at the same time that the evacuation control unit 78 starts the adaptive driving control.

### Information presentation of approach of emergency vehicle in autonomous driving level 4 and higher

In the autonomous vehicles described so far, the driver in the driver's seat is allowed to sleep during the period of autonomous driving at level 4 or higher. Even if an emergency vehicle approaches the subject vehicle Am, the autonomous driving ECU 50 executes adaptive driving control to enable the subject vehicle Am to respond to the emergency vehicle. Therefore, if an emergency vehicle approach notification that notifies the driver of an approach of the emergency vehicle is issued by sound using the audio device 24, the driver will be urged to wake up even when there is no need to do so.

Therefore, the presentation control unit 88 provides a restriction approach notification as a presentation of approach information when an emergency vehicle approaches the subject vehicle Am while the driver is asleep during an autonomous driving period using the autonomous driving level 4 or higher. The restriction approach notification is an emergency vehicle approach notification that is executed only when the driver is asleep. While a normal emergency vehicle approach notification is a notification that indicates the approach of an emergency vehicle by both display and sound, a restriction approach notification is a notification that indicates the approach of an emergency vehicle to occupants by display only, out of the two methods of display and sound. Different from a normal emergency vehicle approach, the restriction approach notification restricts (or cancels) the awakening notification that prompts the occupants to wake up, specifically the notification that indicates the approach of an emergency vehicle by sound.

In the restriction approach notification, at least one display device displays a text message such as "An emergency vehicle is approaching" and/or a still image or animation showing the approach of the emergency vehicle. In addition, when the evacuation control unit 78 starts the adaptive travel control, at least one display device displays at least one still image or animation indicating the content (or type) of the adaptive travel control being executed.

In further detail, when an emergency vehicle approaches the subject vehicle Am during an autonomous driving period at autonomous driving level 3 or below, the presentation control unit 88 will provide a normal emergency vehicle approach notification using both display and audio, regardless of the driver's state of wakefulness (see Level 3 or below in FIG. 4). Similarly, during the period when the manual driving is being executed, the presentation control unit 88 executes the emergency vehicle approach notification using both visual and audio information.

On the other hand, in the first situation in which an approach of the emergency vehicle approaching the subject vehicle Am is detected during an autonomous driving period with autonomous driving level 4 or higher, the presentation control unit 88 provides a restriction approach notification by display only, regardless of the driver's state of wakefulness (see first situation in FIG. 4).

In the second situation in which an emergency vehicle is detected traveling in the same direction as the subject vehicle Am, the presentation control unit 88 changes the notification mode based on the driver's state of wakefulness (see Lv4 of second situation in FIG. 4). In the second situation, when the driver is awake, the presentation control unit 88 executes a normal emergency vehicle approach notification using both a visual display and a sound. On the other hand, in the second situation, when the driver is asleep, the presentation control unit 88 continues the restriction approach notification by display only.

The awakening notification executed in the normal emergency vehicle approach notification may not be restricted to the above-mentioned audio notification. For example, actions that may be executed as awakening notifications include vibrating the seat, forcibly returning the backrest of the driver's seat that has been reclined backward, generating acceleration that shakes the vehicle Am in the forward and backward directions, generating air-conditioned air to promote awakening, and opening the window on the side of the driver's seat. In the restriction approach notification, the execution of these awakening notifications is stopped. Furthermore, the awakening notification does not have to be completely stopped by the restriction approach notification, but may be executed in a restricted state. For example, in the restriction approach notification, a sound or the like indicating the approach of an emergency vehicle may be played back at a volume much lower than that of a normal emergency vehicle approach notification.

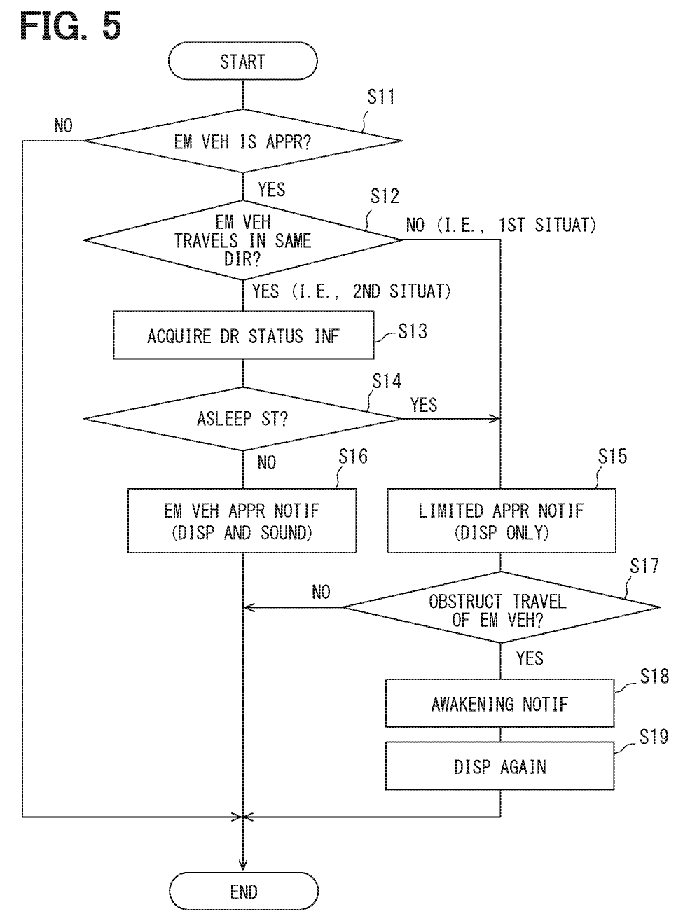

Hereinafter, the details of each process executed by the HMI control device 100 to respond to the approach of an emergency vehicle will be described based on FIGS. 5 to 7 and with reference to FIGS. 1 to 4.

### Emergency vehicle notification process

In the emergency vehicle notification process shown in FIG. 5, an emergency vehicle approach notification or a restriction approach notification is executed based on the approach of an emergency vehicle. The emergency vehicle notification process is started by the HMI control device 100 when the control grasp unit 83 grasps that the autonomous driving of level 4 or higher has begun. The emergency vehicle notification process is repeatedly executed until the information linkage unit 82 determines that the autonomous driving of level 4 or higher has ended.

In S11 of the emergency vehicle notification process, the control grasp unit 83 grasps that an emergency vehicle is approaching the subject vehicle Am based on the recognition result obtained from the autonomous driving ECU 50. If the control grasp unit 83 has not grasped the approach of an emergency vehicle (“NO” at S11), the current emergency vehicle notification process is temporarily terminated. On the other hand, if the control grasp unit 83 grasps the approach of an emergency vehicle (“YES” at S11), in S12, the control grasp unit 83 further grasps whether the emergency vehicle is traveling in the same direction as the subject vehicle Am based on the recognition results obtained from the autonomous driving ECU 50.

If it is unclear whether an emergency vehicle is traveling in the same direction as the subject vehicle Am (“NO” at S12, i.e., first situation), the presentation control unit 88 executes a restriction approach notification in S15, which indicates to the occupants (or a driver) the approach of the emergency vehicle only by displaying the message. The presentation control unit 88 also executes the restriction approach notification in S15 when the emergency vehicle is not traveling in the same direction as the subject vehicle Am. In these restriction approach notifications, audio notifications are stopped (or restricted).

On the other hand, if the emergency vehicle is traveling in the same direction as the subject vehicle Am (“YES” at S12, i.e., second situation), the information acquisition unit 81 acquires driver status information (i.e., wakefulness information) in S13. The information acquisition unit 81 determines whether the driver is asleep or not in S14 based on the acquired latest driver status information. If the driver is asleep (“YES” at S14), the notification control unit 88 executes the restriction approach notification in S15. On the other hand, if the driver is not asleep but is awake (“NO” at S14), the notification control unit 88 executes a normal emergency vehicle approach notification in S16. In this emergency vehicle approach notification, the driver is notified of the approach of an emergency vehicle both sound and display.

In S17 after the start of the restriction approach notification, the control grasp unit 83 estimates whether or not the subject vehicle Am is obstructing the travel of the emergency vehicle based on the recognition result. If it is not estimated that the subject vehicle Am is obstructing the travel of the emergency vehicle (“NO” at S17), the current emergency vehicle notification process is temporarily terminated. On the other hand, if it is estimated that the subject vehicle Am is obstructing the travel of the emergency vehicle (“YES” at S17), the presentation control unit 88 executes a awakening notification in S18. In this case, the presentation control unit 88 prompts the sleeping driver to wake up by at least a sound. Furthermore, in S19 after the start of the awakening notification, the presentation control unit 88 restarts the display indicating the approach of an emergency vehicle from the beginning. The presentation control unit 88 temporarily ends the display of the series of animations that began in S15, and then in S19 displays the animations from the beginning, once again informing the woke up driver of the approach of the emergency vehicle.

### Exterior notification process

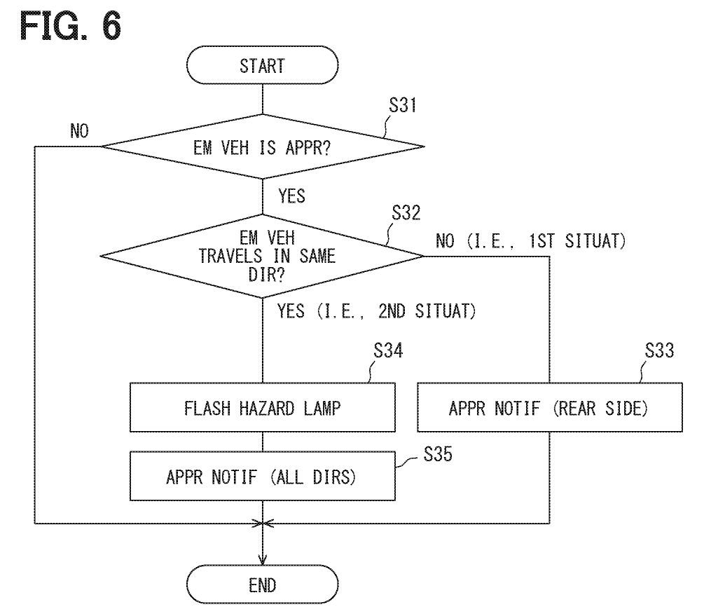

The vehicle exterior notification process shown in FIG. 6 is a process for notifying the exterior of the vehicle of an approach of the emergency vehicle. The vehicle exterior notification process is started by the HMI control device 100 when the control grasp unit 83 grasps that the autonomous driving control of level 3 or higher has started. The vehicle exterior notification process is repeatedly executed until the information linkage unit 82 determines that the autonomous driving control has ended.

In steps S31 and S32 of the exterior notification process, similar to steps S11 and S12 of the emergency vehicle notification process (see FIG. 5), it is determined whether or not an approach of the emergency vehicle has been detected and whether or not the emergency vehicle is traveling in the same direction as the subject vehicle Am. If the approach of an emergency vehicle has not been detected (“NO” at S31), the current vehicle exterior notification process is temporarily terminated.

On the other hand, in the first situation where the approach of an emergency vehicle is detected but it is unclear whether the emergency vehicle is traveling in the same direction as the subject vehicle Am (“YES” at S31 and “NO” at S32), the presentation control unit 88 notifies the outside of the subject vehicle of the approach of the emergency vehicle in S33. In this case, the presentation control unit 88 uses at least the rear display to notify other vehicles around the subject vehicle, particularly the following vehicle, of the approach of the emergency vehicle.

If the second situation is present in which the approach of an emergency vehicle is detected and this emergency vehicle is traveling in the same direction as the subject vehicle Am (“YES” at S31 and “YES” at S32), the presentation control unit 88 cooperates with the body ECU 43 in S34 to start flashing the hazard lamp 44. Furthermore, in S35, the presentation control unit 88 increases the number of exterior displays 45 that provide the emergency vehicle approach notification. In this case, the presentation control unit 88 displays a text message or the like indicating the approach of an emergency vehicle on the front display and side display in addition to the rear display.

### Awakening Response Process

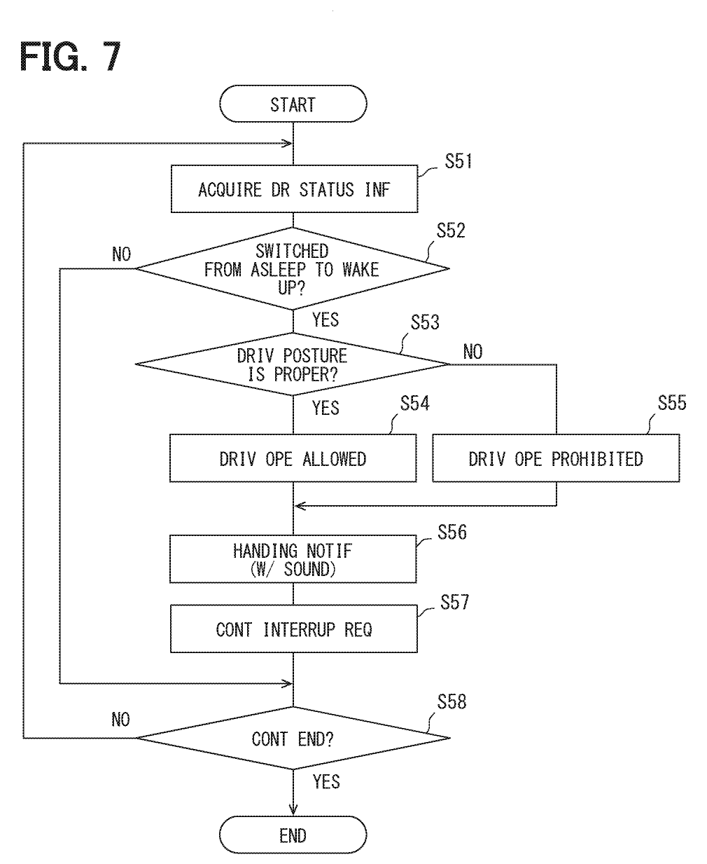

In the awakening response process shown in FIG. 7, the information presentation and driving restrictions are executed to respond to the driver who has woken up after the start of the adaptive travel control by the evacuation control unit 78. The awakening response process is started by the HMI control device 100 when the control grasp unit 83 grasps that the adaptive travel control has started.

In S51 of the awakening response process, the information acquisition unit 81 acquires the driver status information. In step S52, the information acquisition unit 81 determines whether the driver's state has changed from a sleeping state to an awake state based on the acquired latest driver status information. If there is a change in state from a sleeping state to an awake state (“!YES” at S52), the information acquisition unit 81 determines in S53 based on the driver status information whether the driver is able to adopt an appropriate driving posture immediately after waking up.

If the awake driver adopts an appropriate driving posture (“YES” at S53), the request output unit 84 permits the driver to execute the drive operation in S54. In this case, the request output unit 84 outputs a control request to the control switching unit 77 to cancel the prohibition on switching to the manual driving operation. This allows the driver to take over the driving tasks. On the other hand, if the awake driver does not adopt an appropriate driving posture (“NO” at S53), the request output unit 84 prohibits the driver from executing the driving operation in S55. In this case, the request output unit 84 outputs a control request to prohibit the manual driving to the control switching unit 77.

In S56, the presentation control unit 88 notifies by sound that the evacuation control unit 78 is currently executing the adaptive travel control. The presentation control unit 88 notifies the driver of the type of adaptive travel control currently being implemented by displaying the message in conjunction with the audio notification.

In S57, the request output unit 84 outputs a control request to the autonomous driving ECU 50 to request a temporary suspension of the adaptive travel control currently being executed. As a result, the evacuation control unit 78 suppresses the adaptive travel control for a predetermined period of time immediately after the driver wakes up so that the driver can easily grasp the situation.

After the control request is output in S57, or if there is no change in state from a sleeping state to an awake state (“NO” at S52), the control grasp unit 83 determines in S58 based on the control status information whether the adaptive travel control has ended. If the adaptive travel control has ended (“YES” at S58), the current awakening response process ends. On the other hand, if the adaptive travel control is continuing (“NO” at S58), steps S51 to S57 are repeated.

### Outline of First Embodiment

In the first embodiment described so far, even if the approach of an emergency vehicle is detected, the awakening notification for urging the driver to wake up is restricted, so the driver can continue sleeping. In addition, since the approach of an emergency vehicle is indicated to the driver by a display, the driver can understand from the display that an emergency vehicle is approaching, even if the situation occurs suddenly. As a result, emergency vehicle response can be executed in a manner that is convenient for occupants such as a driver.

Additionally, in the first embodiment, if the driver wakes up after the start of the restriction approach notification, the presentation control unit 88 notifies the driver by sound that the subject vehicle Am is currently executing the adaptive travel control to respond to an emergency vehicle. As described above, the presentation control unit 88 can notify the driver in an easily understandable manner that an emergency vehicle is approaching and that the adaptive travel control for the emergency vehicle has already begun. As a result, a system that is convenient for the driver is realized.

In the first embodiment, if the driver wakes up during a period in which the subject vehicle Am is executing the adaptive travel control to respond to an emergency vehicle, the adaptive travel control being executed is temporarily suspended. By suspending the adaptive travel control in this manner, changes in the situation and changes in the vehicle behavior are temporarily suppressed. As a result, the driver can easily grasp the situation of the subject vehicle Am immediately after waking up.

Furthermore, in the first embodiment, when an emergency vehicle approaches the subject vehicle Am while the driver is not asleep, the approach of the emergency vehicle is notified to the driver both by sound and by display. Therefore, a driver who is awake can be sure to recognize the approach of an emergency vehicle. On the other hand, in the case of restriction approach notification when an emergency vehicle approaches the subject vehicle Am while the driver is asleep, the sound notification is stopped and the approach of the emergency vehicle is indicated to the driver only by a display. Therefore, a driver who is asleep can continue to sleep without being forced to wake up unnecessarily.

Additionally, in the first embodiment, it is further determined whether or not an emergency vehicle is traveling in the same direction as the subject vehicle Am. In a first situation in which the approach of an emergency vehicle is detected but it is unclear whether the emergency vehicle is traveling in the same direction as the subject vehicle, a restriction approach notification is executed. In contrast, in a second situation where it is determined that an emergency vehicle is traveling in the same direction, whether or not to provide the restriction approach notification is determined depending on whether or not the driver is asleep. As a result of the above, it is possible to avoid a situation in which the driver is awakened in the early stage of approach when the relative position of the emergency vehicle is unclear. This reduction in trouble can make the emergency vehicle response more convenient for a driver.

In addition, in the first embodiment, if the driver is asleep in the second situation, a restriction approach notification is executed. If the driver is not asleep in the second situation, an emergency vehicle approach notification is executed to inform the driver of the approach of an emergency vehicle by both sound and display. As described above, even if the driver is in an awake state, the execution of the sound notification is postponed until the second situation occurs. Therefore, it is possible to reduce the trouble to the driver who is executing another task.

Furthermore, in the first embodiment, after the start of the restriction approach notification, if the subject vehicle Am is obstructing the travel of an emergency vehicle, the awakening notification is executed. As a result of the above, in a situation where it is difficult to respond appropriately using the adaptive travel control, it is possible to take over the response to the emergency vehicle to the driver.

Additionally, in the first embodiment, after the start of the awakening notification, the display indicating the approach of an emergency vehicle is restarted from the beginning. As described above, the driver who has woken up can properly understand the situation of the subject vehicle Am by checking the contents of the display that has been replayed from the beginning. As a result, the driver is more likely to quickly begin responding to the emergency vehicle.

In the first embodiment, when an emergency vehicle approaches the subject vehicle Am, the approach of the emergency vehicle is notified to the outside of the vehicle using the exterior display 45 mounted on the subject vehicle Am. According to the above, the approach information of an emergency vehicle can be shared with other vehicles around the subject vehicle. As a result, the subject vehicle Am can more easily obtain cooperation from other vehicles through the adaptive travel control, and can smoothly avoid the emergency vehicle.

Furthermore, in the first embodiment, when it is determined that an emergency vehicle is traveling in the same direction as the subject vehicle Am, in addition to an external notification being provided by the exterior display 45, the hazard lamps 44 of the subject vehicle Am begin to flash. As a result of the above, other vehicles around the subject vehicle can prepare for the behavior of the subject vehicle Am to avoid the emergency vehicle. As a result, the subject vehicle Am can smoothly execute the adaptive travel control.

Additionally, in the first embodiment, the manual driving by a driver who has changed from a sleeping state to an awake state is prohibited. Therefore, it is possible to avoid a situation in which a driver who has just woken up and is still half asleep inputs an incorrect manual driving operation, causing the behavior of the subject vehicle Am to become unstable.

In the first embodiment, the information acquisition unit 81 corresponds to the "state grasp unit," and the control grasp unit 83 corresponds to the "approach grasp unit." In addition, the function of the request output unit 84 that executes the processing of S55 corresponds to the "operation restriction unit", the function of the request output unit 84 that executes the processing of S57 corresponds to the "response restriction unit", and the presentation control unit 88 corresponds to the "notification execution unit". Furthermore, the HMI control device 100 corresponds to a "vehicle control device."

### Second Embodiment

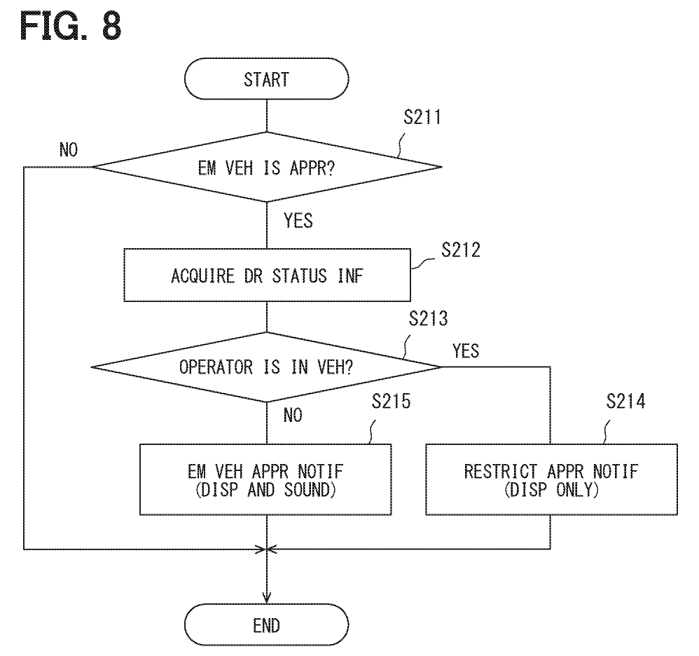

FIG. 8 illustrates a second embodiment of the present disclosure, which is an example of modification of the first embodiment. The HMI control device 100 of the second embodiment is mounted on a service vehicle that provides mobility services. Mobility services provide users with transportation to their destinations. The service vehicle is equipped with an autonomous driving ECU 50 and is capable of autonomous driving at level 4 or higher. The service vehicle may or may not have an operator on a vehicle. The operator sits in the driver's seat of the service vehicle so as to be able to operate the driving operation unit. The operator is a occupant who takes over control of the driving operation from the autonomous driving ECU 50 in a situation where it is difficult for the autonomous driving ECU 50 to drive the vehicle.

Hereinafter, the details of the emergency vehicle notification process executed by the HMI control device 100 mounted on the service vehicle will be described based on FIG. 8 with reference to FIGS. 1 to 3. The emergency vehicle notification process of the second embodiment is started by the HMI control device 100 when the service vehicle starts the service under autonomous driving. The emergency vehicle notification process is repeatedly executed until the service vehicle has finished the service.

In S211 of the emergency vehicle notification process, the control grasp unit 83 grasps that an emergency vehicle is approaching the subject vehicle Am based on the recognition result obtained from the autonomous driving ECU 50. If the control grasp unit 83 has not grasped the approach of an emergency vehicle (“NO” at S211), the current emergency vehicle notification process is temporarily terminated. On the other hand, if the control grasp unit 83 grasps the approach of an emergency vehicle (“YES” at S211), the information acquisition unit 81 acquires the driver status information in S212. In S213, the information acquisition unit 81 determines whether or not an operator is in the service vehicle based on the acquired latest driver status information.

If an operator is in the service vehicle (“YES” at S213), the presentation control unit 88 executes restriction approach notification in S214. In this way, if an emergency vehicle approaches the service vehicle while an operator is in the service vehicle, the sound notification is stopped. The approach of the emergency vehicle is notified to the user (or occupant) of the service vehicle only by display.

On the other hand, if the operator is not in the service vehicle (“NO” at S213), the presentation control unit 88 executes a normal emergency approach notification in S215. In this way, when an emergency vehicle approaches a service vehicle without an operator in the service vehicle, the approach of the emergency vehicle is notified to occupants both sound and display.

In the second embodiment described above, when no operator is in the service vehicle, the approach of an emergency vehicle is notified to the occupants of the service vehicle by sound. Therefore, occupants can be sure that the in-vehicle system recognizes the approach of an emergency vehicle. This means that the service vehicle can continue to be used safely even without an operator in the service vehicle.

Furthermore, when an operator is in the service vehicle, the sound notification is restricted (or cancelled). In this way, by restricting bothersome notifications, occupants can use the service vehicle comfortably. As a result of the above, it is possible to provide an emergency vehicle response that is convenient for occupants using the service vehicle, depending on whether an operator is in the service vehicle.

### Third Embodiment

The third embodiment of the present disclosure is another modification of the first embodiment. In the third embodiment, when the driver is asleep during an autonomous driving period at autonomous driving level 4 or higher, the feature of notification when an emergency vehicle approaches the subject vehicle Am changes depending on the road environment around the subject vehicle and the content of the adaptive travel control, and the like. In addition, when an emergency evacuation using the adaptive travel control requires the driver to control the subject vehicle Am, i.e., when a request for a driver change occurs, an awakening notification is executed using at least sound to wake the driver up. For example, if in the emergency evacuation, the emergency vehicle becomes unable to travel due to the influence of the subject vehicle Am, or if it becomes difficult to continue evacuation using the autonomous driving function, an awakening notification is issued.

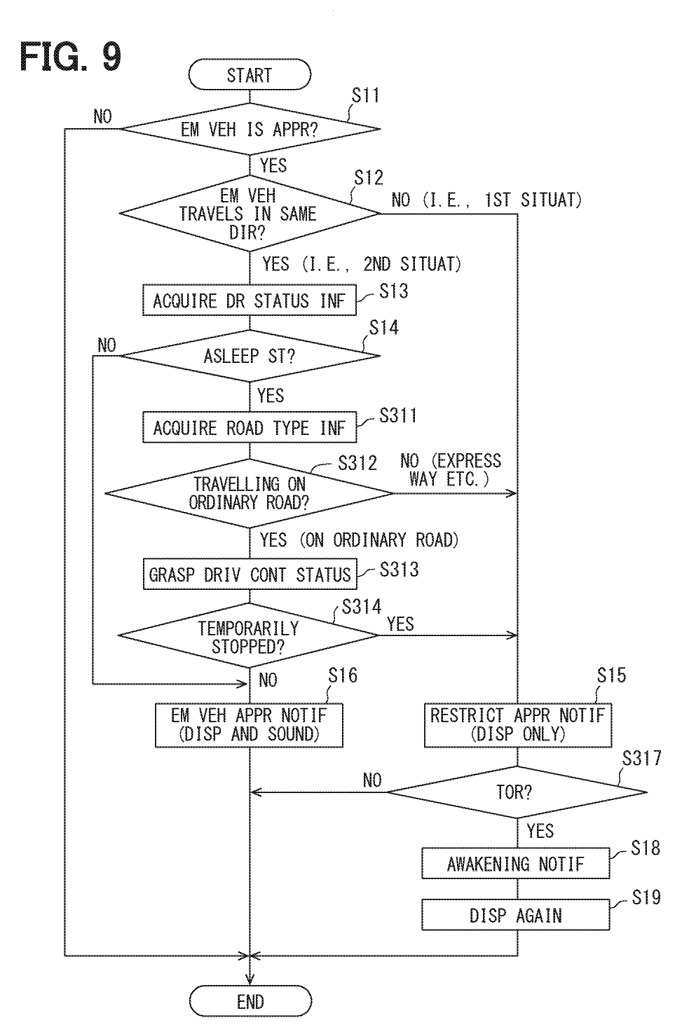

Hereinafter, details of the emergency vehicle notification process executed by the HMI control device 100 of the third embodiment will be described based on FIG. 9 with reference to FIGS. 1 to 3. Similar to the first embodiment, the emergency vehicle notification process of the third embodiment is started when the control grasp unit 83 grasps that autonomous driving of level 4 or higher has begun, and is repeatedly executed until the information linkage unit 82 grasps that autonomous driving of level 4 or higher has ended.

In steps S11 to S14 of the emergency vehicle notification process, substantially the same processes as those in the first embodiment are executed. In S11 and S14, the information acquisition unit 81 determines whether an emergency vehicle is approaching the subject vehicle Am and whether the driver is asleep. If an emergency vehicle is approaching the subject vehicle Am and the driver is awake (“NO” at S14), the notification control unit 88 executes a normal emergency approach notification in S16. In this emergency vehicle approach notification, the driver is notified of the approach of an emergency vehicle both sound and display.

On the other hand, if the driver is asleep (“YES” at S14), the control grasp unit 83 acquires road type information from the autonomous driving ECU 50 in S311. The road type information includes information indicating the type of road on which the subject vehicle Am is traveling. The road type information is prepared by the environment recognition unit 62 based on the locator information, map data, and the like. In S312, the control grasp unit 83 determines whether the road on which the subject vehicle Am is traveling is an ordinary road based on the road type information.

Here, an ordinary road is a road that is accessible to pedestrians and all vehicles, including bicycles and motorcycles. Specifically, the ordinary roads include urban roads, regional roads, and rural roads. The ordinary roads are provided with intersections, traffic signals, crosswalks, sidewalks, and the like. On the other hand, roads other than ordinary roads (hereinafter referred to as "specific roads") are roads on which only certain types of vehicles can travel and on which pedestrians, bicycles, light vehicles, and the like are prohibited. Specifically, expressways and motorways are included in the specific roads. The speed limit on specific roads is set higher than that on the ordinary roads. The specific roads are connected to ordinary roads via interchanges, junctions, and the like.

If the subject vehicle Am is traveling on a specific road such as an expressway (“NO” at S312), the presentation control unit 88 executes restriction approach notification in S15, which notifies the driver of the approach of an emergency vehicle only by display. In the restriction approach notification, the notification by sound is stopped (or restricted). In this way, when an emergency vehicle approaches the subject vehicle Am traveling on a specific road, the intensity of the notification to the driver indicating the approach of the emergency vehicle is set lower than the intensity of the notification when an emergency vehicle approaches the subject vehicle Am traveling on an ordinary road.

On the other hand, if the subject vehicle Am is traveling on an ordinary road (“YES” at S312), the control grasp unit 83 grasps the content of the adaptive travel control that is being or is scheduled to be executed by the evacuation control unit 78 in S313. In S314, the control grasp unit 83 grasps (or determines) whether the subject vehicle Am will be temporarily stopped in response to the adaptive travel control of the emergency vehicle. If the adaptive travel control to temporarily stop the subject vehicle Am is executed (“YES” at S314), the presentation control unit 88 executes a restriction approach notification in S15 to notify the driver of the approach of the emergency vehicle only by display.

On the other hand, if the adaptive travel control is executed to continue driving slowly without stopping the subject vehicle Am (“NO” at S314), the presentation control unit 88 will execute a normal emergency approach notification in S16 to inform the driver of the approach of an emergency vehicle by both sound and display. In this way, the intensity of the notification when the adaptive travel control is executed that does not cause the subject vehicle Am to temporarily stop is set higher than the intensity of the notification when the adaptive travel control is executed that causes the subject vehicle Am to temporarily stop.

When a restriction approach notification is issued because the driver is asleep, the control grasp unit 83 determines in S317 whether a request for driver change has occurred in the adaptive travel control (i.e., emergency evacuation) in response to the approach of the emergency vehicle. If the adaptive travel control using the autonomous driving function of autonomous driving level 4 or higher continues and the control grasp unit 83 has not acquired a request to execute a driver change request (“NO” at S317), the current emergency vehicle notification process is temporarily terminated. On the other hand, if it becomes difficult to continue autonomous driving at level 4 or above and the driver needs to monitor the surroundings or execute driving operations, the control grasp unit 83 acquires a request to execute a driving change request from the autonomous driving ECU 50 (“YES” at S317). In this case, the presentation control unit 88 executes an awakening notification in S18, and prompts the sleeping driver to awaken by at least a sound. Furthermore, in S19 after the start of the awakening notification, the presentation control unit 88 restarts the display indicating the approach of an emergency vehicle from the beginning. The presentation control unit 88 temporarily ends the display of the series of animations that began in S15, and then in S19 displays the animations from the beginning, informing the woke up driver of the approach of the emergency vehicle.

### Outline of third embodiment

The third embodiment described so far also achieves the same effect as the first embodiment, and when the driver is asleep, the awakening notification to wake up the driver is restricted even if the approach of an emergency vehicle is detected. Furthermore, even if the driver wakes up suddenly while an emergency vehicle is approaching, the driver can grasp the situation of the approaching emergency vehicle from the display. Therefore, it is possible to provide an emergency vehicle response that is convenient for the driver and other occupants.

Additionally, in the third embodiment, it is determined whether the road on which the subject vehicle Am is traveling is an ordinary road. The feature of notification to the driver of the approach of the emergency vehicle changes between a case where the driver is asleep and an emergency vehicle approaches the subject vehicle Am on an ordinary road and a case where the driver is asleep and the emergency vehicle approaches the subject vehicle Am on a specific road other than an ordinary road. As described above, when the approach of an emergency vehicle is detected, it is possible to appropriately determine whether or not to prompt the driver to wake up, depending on the driving environment around the subject vehicle. As a result, emergency vehicle response that is convenient for drivers and others can be executed.

In addition, in the third embodiment, when the driver is asleep, the intensity of the notification when an emergency vehicle approaches the subject vehicle Am traveling on an ordinary road is set to be higher than the intensity of the notification when an emergency vehicle approaches the subject vehicle Am traveling on a specific road. Specifically, when an emergency vehicle approaches the subject vehicle Am traveling on an ordinary road, the driver is notified of the approach of the emergency vehicle by both sound and display in an emergency approach notification. On the other hand, when an emergency vehicle approaches the subject vehicle Am traveling on a specific road, the restriction approach notification stops the sound notification and indicates to the driver by display that the emergency vehicle is approaching. In the adaptive travel control for emergency vehicles on specific roads, the influence of external disturbances is smaller than in the adaptive travel control executed on ordinary roads. Therefore, the urgency of waking up the driver is lower on specific roads than on ordinary roads. Therefore, by stopping the sound notification on specific roads, convenience for drivers can be improved.

Furthermore, in the third embodiment, whether or not the subject vehicle temporarily stops is detected in the adaptive travel control for the emergency vehicle. When the driver is asleep, the feature of notification to the occupants of the approach of the emergency vehicle changes between a case where the adaptive travel control for temporarily stopping the subject vehicle is executed and a case where the adaptive travel control for continuing the travel of the subject vehicle is executed. As described above, when the approach of an emergency vehicle is detected, it is possible to appropriately determine whether or not to prompt the driver to wake up, depending on the content of the adaptive travel control for the emergency vehicle. As a result, emergency vehicle response that is convenient for drivers and others can be executed.

In addition, in the third embodiment, when the driver is asleep and the adaptive travel control is executed that does not cause the subject vehicle Am to temporarily stop, the intensity of the notification that indicates to the driver that an emergency vehicle is approaching is set higher than the intensity of the notification that indicates to the driver that an emergency vehicle is approaching when the adaptive travel control is executed that causes the subject vehicle Am to temporarily stop. Specifically, when the adaptive travel control is executed to cause the subject vehicle Am to continue traveling, the sound notification is stopped in the restriction approach notification, and the approach of an emergency vehicle is indicated to the driver by a display. When the vehicle is temporarily stopped by the adaptive travel control, the driver can be given time to check the situation around the subject vehicle. Therefore, the driver's awakening may be suspended. On the other hand, when the adaptive travel control to temporarily stop the subject vehicle Am is executed, the driver is notified of the approach of an emergency vehicle by both sound and display in the emergency vehicle approach notification. When the adaptive travel control is executed to continue travelling with low speed, the driver has less time to check the situation around the subject vehicle than when the subject vehicle is temporarily stopped. Therefore, it may be desirable to notify the driver by sound and display.

In the third embodiment, when the driver is asleep and the driving operation by the driver is required to respond to an emergency vehicle, an awakening notification is executed by the sound. Therefore, even if the notification to wake up the driver is suspended, if the driver's response becomes necessary, the driving operation change can be appropriately executed from the autonomous driving function to the driver.

### Other Embodiments

Although multiple embodiments according to the present disclosure have been described above, the present disclosure is not construed as being restricted to the above-mentioned embodiments, and can be applied to various embodiments and combinations within a scope not departing from the spirit of the present disclosure.

In the above embodiment, the determination of whether the driver is asleep is made based on the driver status information generated by the driver monitor 29. Alternatively, sensing information having a different configuration from that of the driver monitor 29 may be used to determine whether the driver is asleep.

As an example, the information acquisition unit 81 according to the first modification acquires information about the reclining angle of the driver's seat. Based on this angle information, the information acquisition unit 81 determines the sleeping state of the driver when the backrest of the driver's seat is tilted backward. The information acquisition unit 81 may determine the sleeping state of the driver by combining the driver status information with the reclining angle information.

Moreover, the information acquisition unit 81 according to the second modification acquires the driver's biological information, specifically, information such as pulse rate, body temperature, and brain waves. The biological information is measured using a sensor installed in the driver's seat or a wearable device worn by the driver. The information acquisition unit 81 combines the driver status information with biological information to grasp the sleeping state of the driver.

In the third modification of the above embodiment, the first situation and the second situation are not distinguished from each other. In the third modification, when an emergency vehicle approaches and the driver is asleep, the restriction approach notification is executed, whereas when the driver is not asleep, the approach of the emergency vehicle is notified by both sound and display.

In the fourth modification of the first embodiment, in addition to or instead of the driver, it is determined whether a occupant (or occupant) seated in a seat other than the driver's seat is asleep. When an emergency vehicle approaches the subject vehicle Am during an autonomous driving period at autonomous driving level 4 or higher, if the driver is awake, actions and notifications that may awaken occupants may be restricted (or canceled).

In the fifth modification of the third embodiment, when the driver is asleep, the intensity of the notification when an emergency vehicle approaches the subject vehicle Am traveling on an ordinary road is made lower than the intensity of the notification when an emergency vehicle approaches the subject vehicle Am traveling on a specific road. Specifically, when the subject vehicle Am is traveling on an ordinary road, a restriction approach notification is executed, and when the subject vehicle Am is traveling on an expressway or the like, a normal emergency approach notification is executed. As in the above-described fifth modification, the traveling speed of the subject vehicle Am may be taken into consideration, and the intensity of the notification of the approaching emergency vehicle may be adjusted to be higher in a traveling environment where the traveling speed is higher.

In the sixth modification of the third embodiment, when the driver is asleep, the intensity of the notification when the adaptive travel control is executed not to temporarily stop the subject vehicle Am is lower than the intensity of the notification when the adaptive travel control is executed to temporarily stop the subject vehicle Am. Specifically, if the vehicle makes a temporary stop, a normal emergency approach notification is issued, and if the vehicle continues to travel with low speed, a restriction approach notification is issued. As in the sixth modification, it may be assumed that the more a scene includes a temporary stop, the more difficult it is to execute the adaptive travel control, and the intensity of the notification of the emergency vehicle approach may be adjusted to be higher to wake up the driver.

In the seventh modification of the above embodiment, some of the functions of the HMI control device 100 are executed in the autonomous driving ECU 50. That is, in the seventh modification, the system including the HMI control device 100 and the autonomous driving ECU 50 corresponds to the "vehicle control device." In the seventh modification, the environment recognition unit 62 corresponds to the "approach grasp unit", the control switching unit 77 corresponds to the "operation restriction unit", and the evacuation control unit 78 corresponds to the "response restriction unit".

In addition, in the eighth modification of the above embodiment, a system including the HMI control device 100 and the driver monitor 29 corresponds to the "vehicle control device." In the eighth modification, the driver monitor 29 corresponds to the "state grasp unit."

Furthermore, in the ninth modification of the above embodiment, the functions of the HMI control device 100 are integrated into the autonomous driving ECU 50. In this ninth modification, the integrated autonomous driving ECU 50 corresponds to the "vehicle control device."

In the aforementioned embodiments, the respective functions provided by the HMI control device can be also provided by software and hardware for executing the software, only software, only hardware, and complex combinations of them. Further, when such functions are provided by electronic circuits as hardware, each function can be provided by a digital circuit including a large number of logic circuits, or an analog circuit. The software for implementing the function may include, at least in part, a code automatically generated by a neural network or language model trained using, for example, a large amount of learning data.

Each processing unit in the above-described embodiments is hardware for arithmetic processing in cooperation with the RAM. The processor includes at least one calculation core, such as a central processing unit (CPU) or a graphics processing unit (GPU). The processing unit may further include an FPGA (Field-Programmable Gate Array), a NPU (Neural network Processing Unit), or a IP core having another dedicated function. Additionally, the processing unit is not restricted to being a chip configuration in which chips are individually mounted on a printed circuit board. Alternatively, a configuration implemented in an application specific integrated circuit (ASIC), a system on chip (SoC), a chiplet assembly, an FPGA, or the like may correspond to the processing unit.

The form of a storage medium (a non-transitory tangible computer readable medium) that stores various programs and the like may also be appropriately changed. Further, the storage medium is not restricted to the configuration provided on the circuit board, and may be provided in the form of a memory card or the like, inserted into a slot portion, and electrically connected to a control circuit such as an autonomous driving ECU. Furthermore, the storage medium may be an optical disk, a hard disk drive, a solid state drive, or the like that is a copy source or a distribution source of a program to the autonomous driving ECU and the like.

The vehicle equipped with the above autonomous driving ECU and the HMI control device is not restricted to an ordinary private occupant car (i.e., personally owned vehicles, POV) and a service vehicle. The vehicle equipped with the HMI control device may be a vehicle for rental, a vehicle for manned cab, a vehicle for ride-sharing, a cargo vehicle, or a bus. The vehicle may be right-hand drive vehicles or left-hand drive vehicles. Furthermore, the traffic environment in which the vehicle travels may be a left-hand traffic environment or a right-hand traffic environment. The vehicle control according to the present disclosure may be appropriately optimized in accordance with the road traffic laws of each country and region, as well as the steering wheel position of the vehicle.

The devices and methods described in the present disclosure may be implemented by a special purpose computer provided by configuring a processor programmed to execute one or more functions embodied by a computer program. Alternatively, the control unit and the control method described in the present disclosure may be implemented by a special purpose hardware logic circuit. Alternatively, thee control units and methods described in the present disclosure may be implemented by one or more special purpose computers provided by configuring one or more processors that executes a computer program in combination with one or more hardware logic circuits. The computer program may be stored on a computer-readable, non-transitory storage medium as instructions to be executed by a computer.

### Technical features

This specification discloses multiple technical features described in multiple items listed below. Some features may be described in a multiple dependent form, in which subsequent features alternatively refer to preceding features. Some items may be written in a multiple dependent form referring to another multiple dependent form. The technical idea described in the multiple dependent form defines multiple technical ideas.

### Technical feature 1

A vehicle control device is used in a subject vehicle (Am) that can travel by autonomous driving and allows a occupant seated in a driver's seat to sleep. The vehicle control device includes: an approach grasp unit (83) that grasps an approach of an emergency vehicle to the subject vehicle; a state grasp unit (81) that grasps whether the occupant is asleep; and a notification execution unit (88) that executes an emergency vehicle approach notification that notifies the occupant of the approach of the emergency vehicle. When the emergency vehicle approaches the subject vehicle while the occupant is asleep during an autonomous driving period using the autonomous driving, the notification execution unit executes a restriction approach notification that indicates the approach of the emergency vehicle to the occupant using a display while restricting an awakening notification that prompts the occupant to wake up.

### Technical feature 2

In the vehicle control device according to technical feature 1, the notification execution unit notifies the occupant by sound that the subject vehicle is executing an adaptive travel control to respond to the emergency vehicle when the occupant wakes up after starting the restriction approach notification.

### Technical feature 3

The vehicle control device according to technical feature 1 further includes a response restriction unit (S57) that temporarily suspends the adaptive travel control when the occupant wakes up during a period in which the subject vehicle is executing the adaptive travel control to respond to the emergency vehicle.

### Technical feature 4

In the vehicle control device according to any one of technical features 1 to 3, the notification execution unit is configured to: notify the occupant of the approach of the emergency vehicle by both sound and display through the emergency vehicle approach notification when the emergency vehicle approaches the subject vehicle while the occupant is not asleep; and notify the occupant of the approach of the emergency vehicle by display with suspending sound notification through the restriction approach notification when the emergency vehicle approaches the subject vehicle while the occupant is asleep.

### Technical feature 5

In the vehicle control device according to any one of technical features 1 to 4, the approach grasp unit further grasps whether the emergency vehicle is traveling in a same direction as the subject vehicle. The notification execution unit is configured to: execute the restriction approach notification in a first situation in which the approach of the emergency vehicle is grasped but it is unclear whether the emergency vehicle is traveling in the same direction; and determine whether to execute the restriction approach notification depending on whether the occupant is asleep in a second situation in which it is grasped that the emergency vehicle is traveling in the same direction.

### Technical feature 6

In the vehicle control device according to technical feature 5, the notification execution unit is configured to: execute the restriction approach notification when the occupant is asleep in the second situation; and execute the emergency vehicle approach notification to notify the occupant of the approach of the emergency vehicle by both sound and display when the occupant is not asleep in the second situation.

### Technical feature 7

In the vehicle control device according to any one of technical features 1 to 6, the approach grasp unit grasps whether the subject vehicle is obstructing a travel of the emergency vehicle. The notification execution unit executes the awakening notification when the subject vehicle is obstructing the travel of the emergency vehicle after starting the restriction approach notification.

### Technical feature 8

In the vehicle control device according to technical feature 7, the notification execution unit restarts the display indicating the approach of the emergency vehicle from a beginning after starting the awakening notification.

### Technical feature 9

In the vehicle control device according to any one of technical features 1 to 8, the approach grasp unit determines whether a road on which the subject vehicle is traveling is an ordinary road. The notification execution unit changes a feature of the notification to notify the occupant of the approach of the emergency vehicle in a situation where the occupant is asleep depending on a case where the emergency vehicle approaches the subject vehicle on the ordinary road or a case where the emergency vehicle approaches the subject vehicle on a specific road other than the ordinary road.

### Technical feature 10

In the vehicle control device according to technical feature 9, the notification execution unit, in a situation where the occupant is asleep, increases an intensity of the notification to notify the occupant of the approach of the emergency vehicle when the emergency vehicle approaches the subject vehicle travelling on the ordinary road to be higher than an intensity of the notification to notify the occupant of the approach of the emergency vehicle when the emergency vehicle approaches the subject vehicle travelling on the specific road.

### Technical feature 11

In the vehicle control device according to any one of technical features 1 to 10, the approach grasp unit grasps whether the subject vehicle will temporarily stop by the adaptive travel control to respond to the emergency vehicle. the notification execution unit changes a feature of the notification to notify the occupant of the approach of the emergency vehicle in a situation where the occupant is asleep depending on a case where the adaptive travel control to temporarily stop the subject vehicle is executed or a case where the adaptive travel control not to temporarily stop the subject vehicle is executed.

### Technical feature 12

In the vehicle control device according to technical feature 11, the notification execution unit, in a situation where the occupant is asleep, increases an intensity of the notification to notify the occupant of the approach of the emergency vehicle when the adaptive travel control not to temporarily stop the subject vehicle is executed to be higher than an intensity of the notification to notify the occupant of the approach of the emergency vehicle when the adaptive travel control to temporarily stop the subject vehicle is executed.

### Technical feature 13

In the vehicle control device according to any one of technical features 1 to 12, the notification execution unit executes the awakening notification by sound in a situation where the occupant is asleep when a driving operation by the occupant is required to respond to the emergency vehicle.

### Technical feature 14

In the vehicle control device according to any one of technical features 1 to 13, the subject vehicle is a service vehicle that provides a mobility service. The state grasp unit grasps whether an operator is in the service vehicle which is operated by the autonomous driving. The notification execution unit is configured to: notify the approach of the emergency vehicle by both sound and display in a situation where the operator is not in the service vehicle when the emergency vehicle approaches the service vehicle; and notify the approach of the emergency vehicle by display with suspending sound notification in a situation where the operator is in the service vehicle when the emergency vehicle approaches the service vehicle.

### Technical feature 15

In the vehicle control device according to any one of technical features 1 to 14, the notification execution unit notifies an outside of the subject vehicle of the approach of the emergency vehicle using an exterior display (45) mounted on the subject vehicle when the emergency vehicle approaches the subject vehicle.

### Technical feature 16

In the vehicle control device according to technical feature 15, the approach grasp unit further grasps whether the emergency vehicle is traveling in a same direction as the subject vehicle. The notification execution unit starts flashing a hazard light (44) of the subject vehicle in addition to outside notification using the exterior display when the approach grasp unit grasps that the emergency vehicle is traveling in the same direction as the subject vehicle.

### Technical feature 17

The vehicle control device according to any one of technical features 1 to 16 further includes an operation restriction unit (S55) that prohibits a manual driving operation by the occupant who has changed from a sleep state to a wakeful state.

### Technical feature 18

A vehicle control program is used in a subject vehicle (Am) that can travel by autonomous driving and allows an occupant seated in a driver's seat to sleep. The vehicle control program causes at least one processing unit (11) to execute a process including: grasping an approach of an emergency vehicle to the subject vehicle (S11); grasping whether the occupant is asleep (S13, S14); and executing a restriction approach notification that notifies the occupant of the approach of the emergency vehicle by display while restricting an awakening notification that prompts the occupant to wake up when the emergency vehicle approaches the subject vehicle while the occupant is asleep during an autonomous driving period using the autonomous driving (S15).

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A vehicle control device used for a subject vehicle that can travel by autonomous driving and allows an occupant seated in a driver's seat to sleep, the vehicle control device comprising:
at least one of (i) a circuit and (ii) a processor with a memory storing computer program code executable by the processor, the at least one of the circuit and the processor configured to cause the vehicle control device to:
grasp an approach of an emergency vehicle to the subject vehicle;
grasp whether the occupant is asleep;
execute an emergency vehicle approach notification that notifies the occupant of the approach of the emergency vehicle; and
execute a restriction approach notification that notifies the occupant of the approach of the emergency vehicle using a display while restricting an awakening notification that prompts the occupant to wake up when the emergency vehicle approaches the subject vehicle while the occupant is asleep during an autonomous driving period using the autonomous driving.

2. The vehicle control device according to claim 1, wherein:
the at least one of the circuit and the processor is configured to further cause the vehicle control device to: notify the occupant by sound that the subject vehicle is executing an adaptive travel control to respond to the emergency vehicle when the occupant wakes up after starting the restriction approach notification.

3. The vehicle control device according to claim 1, wherein:
the at least one of the circuit and the processor is configured to further cause the vehicle control device to: temporarily suspend an adaptive travel control when the occupant wakes up during a period in which the subject vehicle is executing the adaptive travel control to respond to the emergency vehicle.

4. The vehicle control device according to claim 1, wherein:
the at least one of the circuit and the processor is configured to further cause the vehicle control device to:
notify the occupant of the approach of the emergency vehicle by both sound and display through the emergency vehicle approach notification when the emergency vehicle approaches the subject vehicle while the occupant is not asleep; and
notify the occupant of the approach of the emergency vehicle by display with suspending sound notification through the restriction approach notification when the emergency vehicle approaches the subject vehicle while the occupant is asleep.

5. The vehicle control device according to claim 1, wherein:
the at least one of the circuit and the processor is configured to further cause the vehicle control device to:
grasp whether the emergency vehicle is traveling in a same direction as the subject vehicle;
execute the restriction approach notification in a first situation in which the approach of the emergency vehicle is grasped but it is unclear whether the emergency vehicle is traveling in the same direction; and
determine whether to execute the restriction approach notification depending on whether the occupant is asleep in a second situation in which it is grasped that the emergency vehicle is traveling in the same direction.

6. The vehicle control device according to claim 5, wherein:
the at least one of the circuit and the processor is configured to further cause the vehicle control device to:
execute the restriction approach notification when the occupant is asleep in the second situation; and
execute the emergency vehicle approach notification to notify the occupant of the approach of the emergency vehicle by both sound and display when the occupant is not asleep in the second situation.

7. The vehicle control device according to claim 1, wherein:
the at least one of the circuit and the processor is configured to further cause the vehicle control device to:
grasp whether the subject vehicle is obstructing a travel of the emergency vehicle; and
execute the awakening notification when the subject vehicle is obstructing the travel of the emergency vehicle after starting the restriction approach notification.

8. The vehicle control device according to claim 7, wherein:
the at least one of the circuit and the processor is configured to further cause the vehicle control device to: restart the display indicating the approach of the emergency vehicle from a beginning after starting the awakening notification.

9. The vehicle control device according to claim 1, wherein:
the at least one of the circuit and the processor is configured to further cause the vehicle control device to:
determine whether a road on which the subject vehicle is traveling is an ordinary road; and
change a feature of the notification to notify the occupant of the approach of the emergency vehicle in a situation where the occupant is asleep depending on a case where the emergency vehicle approaches the subject vehicle on the ordinary road or a case where the emergency vehicle approaches the subject vehicle on a specific road other than the ordinary road.

10. The vehicle control device according to claim 9, wherein:
the at least one of the circuit and the processor is configured to further cause the vehicle control device to, in a situation where the occupant is asleep, increase an intensity of the notification to notify the occupant of the approach of the emergency vehicle when the emergency vehicle approaches the subject vehicle travelling on the ordinary road to be higher than an intensity of the notification to notify the occupant of the approach of the emergency vehicle when the emergency vehicle approaches the subject vehicle travelling on the specific road.

11. The vehicle control device according to claim 1, wherein:
the at least one of the circuit and the processor is configured to further cause the vehicle control device to:
grasp whether the subject vehicle will temporarily stop by an adaptive travel control to respond to the emergency vehicle; and
change a feature of the notification to notify the occupant of the approach of the emergency vehicle in a situation where the occupant is asleep depending on a case where the adaptive travel control to temporarily stop the subject vehicle is executed or a case where the adaptive travel control not to temporarily stop the subject vehicle is executed.

12. The vehicle control device according to claim 11, wherein:
the at least one of the circuit and the processor is configured to further cause the vehicle control device to, in a situation where the occupant is asleep, increase an intensity of the notification to notify the occupant of the approach of the emergency vehicle when the adaptive travel control not to temporarily stop the subject vehicle is executed to be higher than an intensity of the notification to notify the occupant of the approach of the emergency vehicle when the adaptive travel control to temporarily stop the subject vehicle is executed.

13. The vehicle control device according to claim 1, wherein:
the at least one of the circuit and the processor is configured to further cause the vehicle control device to: execute the awakening notification by sound in a situation where the occupant is asleep when a driving operation by the occupant is required to respond to the emergency vehicle.

14. The vehicle control device according to claim 1, wherein:
the subject vehicle is a service vehicle that provides a mobility service; and
the at least one of the circuit and the processor is configured to further cause the vehicle control device to:
grasp whether an operator is in the service vehicle which is operated by the autonomous driving;
notify the approach of the emergency vehicle by both sound and display in a situation where the operator is not in the service vehicle when the emergency vehicle approaches the service vehicle; and
notify the approach of the emergency vehicle by display with suspending sound notification in a situation where the operator is in the service vehicle when the emergency vehicle approaches the service vehicle.

15. The vehicle control device according to claim 1, wherein:
the at least one of the circuit and the processor is configured to further cause the vehicle control device to: notify an outside of the subject vehicle of the approach of the emergency vehicle using an exterior display (45) mounted on the subject vehicle when the emergency vehicle approaches the subject vehicle.

16. The vehicle control device according to claim 15, wherein:
the at least one of the circuit and the processor is configured to further cause the vehicle control device to:
grasp whether the emergency vehicle is traveling in a same direction as the subject vehicle; and
start flashing a hazard light (44) of the subject vehicle in addition to outside notification using the exterior display when the emergency vehicle is traveling in the same direction as the subject vehicle.

17. The vehicle control device according to claim 1, wherein:
the at least one of the circuit and the processor is configured to further cause the vehicle control device to: prohibit a manual driving operation by the occupant who has changed from a sleep state to a wakeful state.

18. The vehicle control device according to claim 1, wherein:
the at least one of the circuit and the processor is configured to cause the vehicle control device to:
grasp an approach of an emergency vehicle to the subject vehicle as an approach grasp unit;
grasp whether the occupant is asleep as a state grasp unit; and
execute an emergency vehicle approach notification that notifies the occupant of the approach of the emergency vehicle as a notification execution unit.

19. A vehicle control method used for a subject vehicle that can travel by autonomous driving and allows an occupant seated in a driver's seat to sleep, the vehicle control method comprising a process executed by at least one processing unit, the process including:
grasping an approach of an emergency vehicle to the subject vehicle;
grasping whether the occupant is asleep; and
executing a restriction approach notification that notifies the occupant of the approach of the emergency vehicle by display while restricting an awakening notification that prompts the occupant to wake up when the emergency vehicle approaches the subject vehicle while the occupant is asleep during an autonomous driving period using the autonomous driving.

20. A non-transitory computer readable storage medium comprising instructions being executed by a computer, the instructions including a computer-implemented method for a subject vehicle that can travel by autonomous driving and allows an occupant seated in a driver's seat to sleep, the instructions including:
grasping an approach of an emergency vehicle to the subject vehicle;
grasping whether the occupant is asleep; and
executing a restriction approach notification that notifies the occupant of the approach of the emergency vehicle by display while restricting an awakening notification that prompts the occupant to wake up when the emergency vehicle approaches the subject vehicle while the occupant is asleep during an autonomous driving period using the autonomous driving.
